(19) United States
(12) Patent Application Publication
(10) Pub. No.: US 2025/0323245 A1
(43) Pub. Date: Oct. 16, 2025

(54) CATHODE ACTIVE MATERIAL PARTICLES ENCAPSULATED IN PYROGENIC, NANOSTRUCTURED MAGNESIUM OXIDE, AND METHODS OF MAKING AND USING THE SAME

(71) Applicant: Evonik Operations GmbH, Essen (DE)

(72) Inventors: Daniel Esken, Erlensee (DE); Marcel Herzog, Karlstein (DE); Christian Hofmann, Schluechtern (DE); Franz Schmidt, Gross-Gerau (DE); Ryo Takata, Shanghai (CN); Daniel Dehe, Bruchkoebel (DE)

(73) Assignee: Evonik Operations GmbH, Essen (DE)

(21) Appl. No.: 18/870,495

(22) PCT Filed: May 24, 2023
(86) PCT No.: PCT/EP2023/063942

§ 371 Date: Nov. 29, 2024

(30) Foreign Application Priority Data
Jun. 3, 2022 (EP) 22177299.9

(51) Int. Cl. H01M 4/36; C01F 5/06; H01M 4/525; H01M 10/0525

(52) U.S. Cl. CPC H01M 4/366; C01F 5/06; H01M 4/525; H01M 10/0525; C01P 2002/85; C01P 2004/03; C01P 2004/52; C01P 2004/62; C01P 2004/64; C01P 2004/84; C01P 2006/11; C01P 2006/12; C01P 2006/40

(57) ABSTRACT

A Process for producing a coated mixed lithium transition metal oxide starts with dry mixing of a mixed lithium transition metal oxide and a pyrogenically produced, nanostructured magnesium oxide in a mixing unit having a specific electrical power of 0.05-1.5 KW per kg of the mixed lithium transition metal oxide. The coated mixed lithium transition metal oxide finds application as an active positive electrode material for a lithium-ion battery, and electric and/or electronic devices.

### FIELD OF THE INVENTION

The invention relates to a method of producing encapsulated cathode active material particles in which lithium-mixed oxide particles and fumed, nanostructured magnesium oxide are mixed dry under shearing conditions. The invention further relates to the fumed magnesium oxide coated cathode material as well as to a battery cell containing these encapsulated lithium-mixed oxide particles and to the use thereof.

### BACKGROUND OF THE INVENTION

Various energy storage technologies have recently attracted much attention of public and have been a subject of intensive research and development at the industry and in the academia. As energy storage technologies are extended to devices such as cellular phones, camcorders and notebook PCs, and further to electric vehicles, demand for high energy density batteries used as a source of power supply of such devices is increasing. Secondary lithium-ion batteries are one of the most important battery types currently used.

The secondary lithium-ion batteries are usually composed of an anode made of a carbon material or a lithium-metal alloy, a cathode made of a lithium-metal oxide, and an electrolyte in which a lithium salt is dissolved in an organic solvent. The separator of the lithium-ion battery provides the passage of lithium ions between the positive and the negative electrode during the charging and the discharging processes.

One of the general problems with cathode materials is their rapid aging and thus the loss of performance during cycling. This phenomenon is especially relevant for nickel manganese cobalt mixed oxides (NMC) with a high nickel content. During cycling the positive electrode material suffers from several electrochemical degradation mechanisms. The deactivation of the positive electrode material occurs by several electrochemical degradation mechanisms. Surface transformations such as the formation of a NiO-like phase due to the reduction of Ni⁴⁺in a highly delithiated state and oxygen loss as well as transition metal rearrangement destabilizes the crystal structure. These phase transitions have been associated with initial cracks appearing at the cathode particle surface and subsequent particle disintegration. In addition, the electrolyte decomposes at the reactive surface of NMC and the electrolyte decomposition products deposit at the interface of the cathode material, which leads to an increased resistance. Furthermore, the conducting salt LiPF₆, which is commonly used in liquid electrolytes reacts with the trace amounts of H₂O present in all commercial formulations to form HF. This highly reactive compound causes lattice distortion in the cathode material by dissolution of transition metal ions out of the surface of the cathode material into the electrolyte. All these degradation mechanisms result in a decrease of capacity, performance and cycle life.

It is known that coating of mixed lithium transition metal oxide particles with some metal oxides can inhibit unwanted reactions of the electrolyte with the electrode materials and thus improve the long-life stability of the lithium-ion batteries.

International patent application no. WO 00/70694 describes mixed transition metal oxide particles coated with oxides or mixed oxides of Zr, Al, Zn, Y, Ce, Sn, Ca, Si, Sr, Mg and Ti. They are obtained by suspending the uncoated particles in an organic solvent, admixing the suspension with a solution of a hydrolysable metal compound and a hydrolysis solution, and then filtering off, drying and calcining the coated particles.

The coating of cathode materials of lithium-ion batteries with metal oxides, such as Aₗ2_{O}3, TiO₂, ZrO₂ and MgO for improving their cycling performance, is known.

Chinese patent document CN 112194196 describes a composite coating agent prepared from at least one of metal and/or non-metal oxide and ammonium salt. The metal oxide is said to be at least one of MgO, Al₂O₃, La₂O₃, ZrO₂ and N_{b}O₅. The non-metal oxide is SiO₂. The ammonium salt is at least one of NH₄F, (NH₄)₃AlF₆, NH₄H₂PO₄ and (NH₄)₂WO₄. The composite coating agent is prepared by at least one process of ball-milling, jet-milling, calcination, wet mixing and spray-drying. The composite coating agent is said to form a uniform coating on the surface of single crystal material, and can improve cycle performance and safety of material.

Chinese patent document CN110165205A describes a cathode material comprising a lithium metal oxide substrate, a first coating layer (metal N oxide, N is Al, Zr, Mg, Ti, Co, Y, Ba, Cd), and a second coating layer (N′ oxide, N′is B, Sn, S, P). The described method includes adding metal N oxide nanoparticle into deionized water, stirring, ultrasonic dispersing, adding cathode material substrate, stirring, filtering, drying at 80-150° C., mixing with N′ simple substance (or N′ compd.), calcining at 150-500° C., and cooling to obtain final product.

Chinese Patent Document CN108172810A describes a preparation method of nanoparticle coated lithium nickel manganese oxide cathode material. The patent describes preparing composite MgO nanoparticles, adding Et silicate into oxalic acid, adding composite MgO nanoparticles and Dy-doped Li Ni Mn oxide active substance, carrying out ultrasonic dispersion, injecting into a stainless steel mold, standing and drying to obtain the products.

Examples of use of MgO in cathode materials are provided in the following articles. “Mesoporous carbon material as cathode for high performance lithium-ion capacitor” Chinese Chemical Letters (2018), 29(4) 620-623 CODEN CCLEE7;ISSN: 1001-8417, by Zhang et al. Mg citrate was used as the precursor of the C mesoporous and the nano-sizes MgO particles as template provided by the Mg citrate.

“Flexible 3D multifunctional MgO-decorated carbon foam@CNTs hybrid as self-supported cathode for high performance lithium-sulfur batteries” in Advanced Functional Materials (2017), 27(37), n/a CODEN: AFMDC6; ISSN: 1616-301X by Xiang et al. describes the use of ultrafine MgO nano-particles with lithium-sulfur batteries.

“Improvement of cycling performance of lithium-sulfur batteries by using magnesium oxide as a functional additive for trapping lithium polysulfide” in ACS Applied materials & interfaces (2016), 8(6), 4000-4006 CODEN: AAMICK; ISSN: 1994-8244, describes the use of MgO nanoparticles for trapping lithium polysulfides in lithium-sulfur batteries.

“Surface modification of positive electrode materials for lithium-ion batteries” in Thin Solid Films (2014), 572, 200-207 CODEN: THSFAP; ISSN: 0040-6090” by C. M. et al. describes the various types of surface treatment of cathode material particles of Li-ion batteries.

“Effects of MgO coating on the structural and electrochemical characteristics of LiCoO₂ as cathode materials for lithium-lon battery” in Chemistry of materials 2014, 26(8), 2537-2543 CODEN: CMATEX; ISSN: 0897-4756 describes MgO-coated LiCoO₂ annealed at various temperatures of 750-810 C. for finding an optimum annealing temperature.

CN 111 354 936 discloses positive electrode materials based on lithium oxides coated with nano-sized magnesium oxide.

In the article “Performance improvement of surface-modified LiCoO₂ Cathode Materials: An infrared absorption and X-Ray Photoelectron Spectroscopic Investigation” of Wang Zhaoxiang et al., published in Journal of the Electrochemical Society, vol. 150, no. 2, (2003), pages A199-A208, ISSN: 0013-4651, comparative studies to understand the electrochemical performance improvement of nanometer-sized magnesium oxide modified commercial LiCoO₂ cathode materials.

Although the nano-size MgO particles have been used as additives in lithium-ion batteries their effectiveness in improving their cycling stability has been limited by poor dispersibility. Practical ways to improve the batteries long life are often limited. Thus, in the case of magnesium oxide, the use of commercially available nano-sized MgO particles often leads to inhomogeneous distribution and large agglomerated MgO particles on the surface of the core cathode material and as a result, minimal or no improvements in cycling performance are observed when compared with non-coated cathode materials.

The problem addressed by the present invention is that of providing a modified mixed lithium transition metal oxide as a cathode material, especially for high nickel NMC (Nickel, Magnesium, Cobalt) type, for use in lithium-ion batteries. Such modified cathode materials provide a higher cycling stability than that of the unmodified materials.

In the course of thorough experimentation, it was surprisingly found that pyrogenically produced, nanostructured MgO may successfully be used for coating cathode materials using a dry mixing process for coating the metal oxide on the cathode materials. It was also surprisingly found that further surface modification of the pyrogenically produced, nanostructured metal oxide prior to the dry mixing may further improve the coverage and homogeneity of the coating significantly.

### SUMMARY OF THE INVENTION

The invention provides a process for producing a coated active cathode material, the coated active cathode material, and the use of the coated active cathode material in a lithium-ion battery. The lithium-ion battery of the present invention can be used in electronic and electrical apparatuses including, for example, mobile phones, computers (lap top computers, desk top computers, computer pads), electronic watches, key fabs, electric appliances, power tools, vacuum cleaners, electric lawn mowers and electric vehicles.

According to a first aspect of the present invention there is provided a process for producing a coated active cathode material, preferably being a coated mixed lithium transition metal oxide. The process is characterized in that the coated active cathode material is obtained by subjecting an active cathode material, preferably being a mixed lithium transition metal oxide and a pyrogenically produced magnesium oxide to dry mixing in a mixing unit under shearing conditions, wherein the coated active cathode material, preferably being a mixed lithium transition metal oxide, is in the form of particles, and the magnesium oxide has a BET surface area of 5-300 m²/g (DIN 9277:2014), a mono-modally and narrow particle size distribution with a mean aggregate diameter d₅₀ of 5-150 nm, as determined by static light scattering (SLS) after 60 seconds of ultrasonic treatment at 25° C. of a mixture consisting of 5% by weight of the particles and 95% by weight of a 0.5 g/L solution of sodium pyrophosphate in water.

The pyrogenically produced MgO is hydrophilic. Preferably, in an embodiment, the pyrogenically produced MgO is subjected to a surface modification to become hydrophobic.

In an embodiment, the mixing unit has a specific electrical power of 0.05-1.5 KW per kg of the mixed cathode material.

The coated active cathode material, preferably being a coated mixed lithium transition metal oxide, is in the form of particles, and the magnesium oxide has a BET surface area of 5-300 m²/g, a mono-modally and narrow particle size distribution with a mean aggregate diameter d₅₀ of 5-150 nm, more preferably 10-120 nm, even more preferably 20-100 nm, as determined by static light scattering (SLS) after 60 seconds of ultrasonic treatment at 25° C. of a mixture consisting of 5% by weight of the particles and 95% by weight of a 0.5 g/L solution of sodium pyrophosphate in water.

SEM-EDX mapping of the coated active cathode material provides a fully and homogeneous coverage of MgO around all cathode particles, with no or only few larger magnesium oxide agglomerates.

In an embodiment, the process is characterized in that the specific electrical power of the mixing unit is 0.1-1000 KW, the volume of the mixing unit is 0.1 L to 2.5 m³, and the speed of a mixing tool in the mixing unit is 5-30 m/s.

The span (d₉₀-d₁₀)/d₅₀ of particles of the magnesium oxide and/or of the mixed oxide comprising magnesium is 0.4-1.2, as determined by static light scattering (SLS) after 60 seconds of ultrasonic treatment at 25° C. of a mixture consisting of 5% by weight of the particles and 95% by weight of a 0.5 g/L solution of sodium pyrophosphate in water.

The active cathode material may comprise mixed lithium transition metal oxide particles selected from the group consisting of lithium-cobalt oxides, lithium-manganese oxides, lithium-nickel-cobalt oxides, lithium-nickel-manganese-cobalt oxides, lithium-nickel-cobalt-aluminum oxides, lithium-nickel-manganese oxides, and a mixture thereof.

The nanostructured magnesium oxide made by a flame process has a mono-modally and narrow particle size distribution in combination with an excellent dispersibility during the dry coating process of the cathode material. These particles lead to an excellent interaction and proper adhesion to the cathode active material.

Furthermore, the additional surface modification of these particles leads to further improvements in interaction and adhesion to the cathode active material. This results in a complete de-agglomeration of the magnesium oxide agglomerates and finally provide a fully and homogenously covered cathode active material particles by the fumed, nanostructured and surface modified magnesium oxide.

It has been found that by using a high intensity dry coating process in combination with the pyrogenic, nanostructured MgO particles the present invention method results in significantly improved dispersibility of the MgO particles and homogeneous coating. During the dry mixing the applied shear forces (mixing) decompose any MgO agglomerates into tiny aggregates which have a very high tendency to settle down on the surface of the cathode active material powder resulting in very good interaction and adhesion which in turn results in a homogeneous coating. In contrast, conventional MgO particles, which are not pyrogenically produced and nanostructured, are composed of isolated, spherical particles (which are the result of milling coarser MgO particles) and do not show such behaviour.

These and other features and advantages of the invention will become better understood from the following detailed description in conjunction with the following figures.

### BRIEF DESCRIPTION OF THE DRAWINGS

FIG. 1(a) shows the particle size distribution of a pyrogenically produced, nanostructured, hydrophilic magnesium oxide according to an embodiment of the present invention.

FIG. 1(b) shows the particle size distribution of a conventional non-fumed magnesium oxide.

FIGS. 2(a) and 2(b) shows the SEM-EDX mapping of fumed magnesium oxide (“magnesia) coating additives on a NMC cathode active material. In FIG. 2(b) the magnesium oxide of FIG. 1(a) was used. In FIG. 2(b) the magnesium oxide of FIG. 1(a) was surface modified to become hydrophobic before applying it on the NMC cathode active material.

FIG. 2(c) shows the SEM-EDX mapping of the non-fumed magnesium oxide of FIG. 1(b) on the NMC cathode active material as a comparative example.

FIG. 3 shows a lithium-ion battery inside an apparatus according to an embodiment of the present invention.

### DETAILED DESCRIPTION OF THE INVENTION

According to a first aspect of the invention there is provided a method of producing encapsulated cathode active material particles in which lithium-mixed oxide particles, preferably a mixed lithium transition metal oxide, and fumed, nanostructured and surface modified magnesium oxide are mixed dry under shearing conditions. A second aspect of the invention relates to the fumed magnesium oxide coated cathode material, and a third aspect of the invention relates to a battery cell containing these encapsulated lithium-mixed oxide particles.

### Process for Producing the Coated Lithium Transition Metal Oxide

According to a first aspect of the present invention, there is provided a process for producing a coated mixed lithium transition metal oxide, wherein a mixed lithium transition metal oxide and a pyrogenically produced, nanostructured magnesium oxide are subjected to dry mixing under shearing conditions.

The fumed, nanostructured magnesium oxide is preferably also surface modified to become hydrophobic prior to the dry mixing.

Dry mixing may be performed, for example, in a mixing unit having a specific electrical power of 0.05-1.5 k per kg of the mixed lithium transition metal oxide. Dry mixing is understood to mean that no liquid is added or used during the mixing process, that is e.g., substantially dry powders are mixed together. However, it is possible that there are trace amounts of moisture or some other than water liquids present in the mixed feedstocks or that these include crystallization water.

If the used specific electrical power is less than 0.05 kW per kg of the mixed lithium transition metal oxide, this gives an inhomogeneous distribution of the magnesium oxide on top of the lithium transition metal oxide, which may be not firmly bonded to the core material of the lithium transition metal oxide. A specific electrical power of more than 1.5 kW per kg of the mixed lithium transition metal oxide leads to poorer electrochemical properties. In addition, there is the risk that the coating will become brittle and prone to fracture. The nominal electrical power of the mixing unit can vary in a wide range, e.g., from 0.1 kW to 1000 kW. Thus, it is possible to use mixing units on the laboratory scale with a nominal power of 0.1-5 kW or mixing units for the production scale with a nominal electrical power of 10-1000 kW. The nominal electrical power is the nameplate, maximal absolute electrical power of the mixing unit.

The volume of the mixing unit may vary in a wide range. For example, the volume of the mixing unit may range from 0.1 L to 2.5 m³. For example, mixing units on a laboratory scale may have a volume of 0.1-10 L or mixing units for the production scale may have a volume of 0.1-2.5 m³.

Preferably, in the process according to the invention, forced action mixers are used in the form of intensive mixers with high-speed mixing tools. It has been found that a speed of the mixing tool of 5-30 m/s, more preferably of 10-25 m/s, gives the best results. Examples of commercially available mixing units which are suitable for the process of the invention include Henschel mixers and Eirich mixers. The Eirich mixers may be, for example, high intensity Eirich mixers.

The mixing time may vary and may be preferably from 0.1 to 120 minutes, more preferably from 0.2 to 60 minutes, and most preferably from 0.5 to 10 minutes.

The mixing may be followed by a thermal treatment of the mixture for improved binding of the coating to the mixed lithium transition metal oxide particles. However, this treatment is optional in the process according to the invention since in this process, the pyrogenically produced, nanostructured and surface modified magnesium oxide adheres with sufficient firmness to the mixed lithium transition metal oxide. A preferred embodiment of the process according to the invention may not include a thermal treatment after the mixing.

It has been found that the best results regarding the adhesion of the magnesium oxides to the mixed lithium transition metal oxide are obtained when the magnesium oxide has a BET surface area of 5 m²/g-300 m²/g, more preferably of 10 m²/g-200 m²/g and most preferably of 15-150 m²/g. The BET surface area can be determined according to DIN 9277:2014 by nitrogen adsorption according to the Brunauer-Emmett-Teller procedure.

### Pyrogenically Produced MgO

The magnesium oxide used in the process according to the invention is produced pyrogenically, i.e., by a pyrogenic method. A pyrogenic method is also referred to as a “fumed” method. Such “pyrogenic” or “fumed” method involves the reaction of the corresponding metal precursor in a flame hydrolysis or a flame oxidation in an oxyhydrogen flame to form the metal oxide.

A pyrogenically prepared, hydrophilic magnesium oxide is characterized by:

| | |
|---|---|
| Surface area [m²/g] | 50 to 350 |
| Tamped density [g/L] | 20 to 100 |
| Drying loss [%] | less than 5 |
| Loss on ignition [%] | 0.1 to 20 |

The terms “pyrogenically produced or prepared”, “pyrogenic” and “fumed” are used equivalently in the context of the present invention. The fumed magnesium oxides may be prepared by means of flame hydrolysis or flame oxidation. This involves oxidizing or hydrolyzing of hydrolysable or oxidizable starting materials, generally in a hydrogen/oxygen flame. Starting materials typically used for pyrogenic methods include organic or inorganic substances, such as metal chlorides.

Thus, the hydrophilic magnesium oxide according to the present invention can be prepared by means of flame spray pyrolysis, wherein at least one solution of metal precursors, comprising a magnesium salt, a solvent e.g., ethanol, methanol or water is subjected to flame spay pyrolysis.

During the flame spray pyrolysis process, the solution of metal compounds (metal precursors) in the form of fine droplets is typically introduced into a flame, which is formed by ignition of a fuel gas and an oxygen-containing gas, where the used metal precursors are oxidized and/or hydrolyzed to give the corresponding magnesium oxide.

This reaction initially forms highly disperse approximately spherical primary particles, which in the further course of the reaction coalesce to form aggregates. The aggregates can then accumulate into agglomerates. In contrast to the agglomerates, which as a rule can be separated into the aggregates relatively easily by introduction of energy, the aggregates are broken down further, if at all, only by intensive introduction of energy. Said metal oxide powder may be partially destructed and converted into nanometre (nm) range particles advantageous for the present invention by suitable grinding. The produced aggregated compound can be referred to as “fumed” or “pyrogenically produced” magnesium oxide.

The flame spray pyrolysis process is in general described in WO 2015173114 A1 and elsewhere.

The inventive flame spray pyrolysis process preferably comprises the following steps:
a) the solution of metal precursors is atomized to afford an aerosol by means of an atomizer gas,
b) the aerosol is brought to reaction in the reaction space of the reactor with a flame obtained by ignition of a mixture of fuel gas and an oxygen-containing gas to obtain a reaction stream,
c) the reaction stream is cooled and
d) the solid magnesium oxide is subsequently removed from the reaction stream.

Metal precursors employed in the inventive process include magnesium salts such as magnesium chloride, magnesium nitrate or magnesium acetate.

The solvent of this solution can be all typical solvents such as water, ethanol, methanol and others.

The amount of metal precursors in the solution may range of from 5 to 80 wt. %, preferably of from 20 to 70 wt. %, based on the total weight of the solution.

Examples of fuel gases are hydrogen, methane, ethane, natural gas and/or carbon monoxide. It is particularly preferable to employ hydrogen.

The oxygen-containing gas is generally air or oxygen-enriched air. An oxygen-containing

gas is employed in particular for embodiments where for example a high BET surface area of the magnesium oxide to be produced is desired. The total amount of oxygen is generally chosen such that, it is sufficient at least for complete conversion of the fuel gas and the metal precursors.

For obtaining the aerosol, the vaporized solution containing metal precursors can be mixed with an atomizer gas, such as nitrogen, air, and/or other gases. The resulting fine droplets of the aerosol preferably have an average droplet size of 1-120 μm, particularly preferably of 30-100 μm. The droplets are typically produced using single-or multi-material nozzles. To increase the solubility of the metal precursors and to attain a suitable viscosity for atomization of the solution, the solution may be heated.

The particle size of the magnesium oxides can be varied by means of the reaction conditions, such as, for example, flame temperature, hydrogen or oxygen proportion, magnesium salt quantity, residence time in the flame, or length of the coagulation zone.

The used metal oxide precursors may be atomized dissolved in water or an organic solvent. Suitable organic solvents include methanol, ethanol, n-propanol, isopropanol, n-butanol, tert-butanol, 2-propanone, 2-butanone, diethyl ether, tert-butyl methyl ether, tetrahydrofuran, C1-C8-carboxylic acids, ethyl acetate, toluene, petroleum and mixtures thereof.

Thus, the pyrogenically produced, nanostructured and, preferably, surface modified magnesium oxide used in the process according to the invention, is in the form of aggregated primary particles, preferably with a numerical mean aggregate diameter of 5-150 nm, more preferably 10-120 nm, even more preferably 20-100 nm, as determined by transition electron microscopy (TEM). This numerical mean diameter can be determined by calculating the average size of at least 500 particles analysed by TEM.

The mean diameter of the agglomerates is usually 1-2 μm. These mean numerical values can be determined in a suitable dispersion, e.g., in an aqueous dispersion, by a static light scattering (SLS) method. The agglomerates and partly the aggregates can be destroyed e.g., by grinding or ultrasonic treatment of the particles to result in particles with a smaller particle size.

The mean aggregate diameter d₅₀ of the metal oxide is 5-150 nm, more preferably 10-120 nm, even more preferably 20-100 nm, as determined by static light scattering (SLS) after 60 seconds of ultrasonic treatment at 25° C. of a mixture consisting of 5% by weight of the particles and 95% by weight of a 0.5 g/L solution of sodium pyrophosphate in water.

Thus, the pyrogenically produced, nanostructured and preferably surface modified magnesium oxide used in the process of the present invention is preferably characterized by high dispersibility, that is, the ability to form relatively small particles under mild ultrasonic treatment. It is believed, that dispersion under such mild conditions correlates with the conditions during the dry coating process. That means, the agglomerates of the magnesium oxide are destroyed in the mixing process of the present invention in a similar way as under the ultrasonic treatment and are able to form a homogeneous coating of the cathode active material particles. The span (d₉₀-d₁₀)/d₅₀of particles of the magnesium oxide and/or of the mixed oxide comprising magnesium is preferably 0.4-1.2, more preferably 0.5-1.1, and even more preferably 0.6-1.0, as determined by static light scattering (SLS) after 60 s of ultrasonic treatment at 25° C. of a mixture consisting of 5% by weight of the particles and 95% by weight of a 0.5 g/L solution of sodium pyrophosphate in water.

Thus, the pyrogenically produced, nanostructured and surface modified magnesium oxide used in the process of the present invention is preferably characterized by a relatively narrow particle size distribution. This helps to achieve a high-quality magnesium oxide coating on the surface of the transition metal oxide.

The d values d₁₀, d₅₀ and d₉₀ are commonly used for characterizing the cumulative particle diameter distribution of a given sample. For example, the d₁₀ diameter is the diameter at which 10% of a sample's volume is comprised of smaller than d₁₀ particles, the d₅₀ is the diameter at which 50% of a sample's volume is comprised of smaller than d₅₀ particles. The d₅₀ is also known as the “volume median diameter” as it divides the sample equally by volume; the d₉₀ is the diameter at which 90% of a sample's volume is comprised of smaller than d₉₀ particles.

### Surface Treatment of the Pyrogenically Produced MgO.

The pyrogenically produced MgO without any further surface treatment is hydrophilic because it is naturally covered with hydroxyl (—OH) groups. Through surface modification of the pyrogenically produced MgO, hydrophobic MgO is also produced. For example, hydrophobization of the MgO may be performed by reacting the hydroxyl groups with a silane to form —O—Si—R groups. Thus, preferably, the MgO is surface modified, meaning that the surface of the MgO is at least partially covered by silanes.

The pyrogenically produced MgO may be used in its hydrophilic and hydrophobic forms. The use of the hydrophilic MgO does not require any further treatment after synthesis by the pyrogenic process. However, after synthesis by the pyrogenic process, by further treatment with a hydrophobic reagent, such as, for example, silanes, the MgO particles can become hydrophobic. For example, in an embodiment, an octyl silane is covalently bound to the surface of the MgO particles. Both the hydrophilic and the hydrophobic forms of the fumed, nanostructured MgO may be used effectively as coatings using the process of the present invention via dry mixing with the substrate active cathode material. The fumed, nanostructured and surface modified MgO is preferred because it shows more homogeneous coverage of the substrate active cathode material.

In an embodiment, a pyrogenically prepared, surface modified magnesium oxide, is produced which is characterized by:

| | |
|---|---|
| Surface area [m²/g] | 50 to 350 |
| Tamped density [g/L] | 20 to 100 |
| Drying loss [%] | less than 5 |
| Loss on ignition [%] | 0.1 to 20 |

Accordingly, the pyrogenically prepared magnesium oxide is sprayed with a surface modifying agent at room temperature and the mixture is subsequently treated thermally at a temperature of 50 to 300° C., preferably 80-180° C., over a period of 0.5 to 3 hours (“h”).

In an alternative embodiment, surface modification of the pyrogenically prepared magnesium oxide can be carried out by treating the pyrogenic magnesium oxide with a surface modifying agent in vapor form and subsequently treating the mixture thermally at a temperature of 50 to 800° C. over a period of 0.5 to 6 h.

An alternative method for surface modification of the pyrogenically prepared magnesium oxide can be carried out by treating the pyrogenic magnesium oxide with a surface modifying agent in vapor form and subsequently treating the mixture thermally at a temperature of 50 to 800° C. over a period of 0.5 to 6 h.

The thermal treatment can be conducted under protective gas, such as, for example, nitrogen. The surface treatment can be carried out in heatable mixers and dryers with spraying devices, either continuously or batchwise. Suitable devices can be, for example, plowshare mixers or plate, cyclone, or fluidized bed dryers.

The present invention has the advantage that commercially available silanes can be used to modify magnesium oxide and thus individually adapt the properties of magnesium oxide, depending on the desired properties and intended purposes.

As surface modifying agent, it is possible to employ the following compounds and mixtures of the following compounds:
a) Organosilanes of the type (RO)₃Si(CₙH₂ₙ₊₁) and (RO)₃Si(CₙH₂ₙ₋₁), wherein R=alkyl, such as, for example, methyl, ethyl, n propyl, i-propyl, butyl, and n=1-20
b) Organosilanes of the type R′ₓ(RO)_{y}Si(CₙH₂ₙ₊₁) and R′ₓ(RO)_{y}Si(CₙH₂ₙ₋₁) wherein
   R=alkyl, such as, for example, methyl-, ethyl-, n-propyl-, i-propyl-, butyl-
   R′=alkyl, such as, for example, methyl, ethyl, n-propyl, i-propyl, butyl
   R′=cycloalkyl

$$n = 1 - 20$$

$$x + y = 3$$

$$x = 1 , 2 , and$$

$$y = 1 , 2$$

c) Halogen organosilanes of the type X₃Si(CₙH₂ₙ₊₁) and X₃Si(CₙH₂ₙ₋₁), wherein

$$\begin{matrix}X = C l , Br \\ n = 1 - 20\end{matrix}$$

d) Halogen organosilanes of the type X₂(R′)Si(CₙH₂ₙ₊₁) and X₂(R′)Si(CₙH₂ₙ₋₁), wherein

$$X = C l , Br$$

R′=alkyl, such as, for example, methyl, ethyl, n-propyl, i-propyl, butyl
R′=cycloalkyl

$$n = 1 - 20$$

e) Halogen organosilanes of the type X(R′)₂Si(CₙH₂ₙ₊₁) and X(R′)₂Si(CₙH₂ₙ₋₁), wherein

$$X = C l , Br$$

R′=alkyl, such as, for example, methyl, ethyl, n-propyl, i-propyl, butyl
R′=cycloalkyl

$$n = 1 - 20$$

f) Organosilanes of the type (RO)₃Si(CH₂)ₘ-R′
   R=alkyl, such as methyl, ethyl, propyl

$$m = 0.1 - 20$$

R′=methyl-, aryl (for example, —C₆H₅, substituted phenyl residues), C₄F₉, OCF₂—CHF—CF₃, —C₆F₁₃, —O—CF₂—CHF₂, —NH₂, —N3, —SCN, —CH═CH₂, —NH—CH₂—CH₂—NH₂, —N—(CH₂—CH₂—NH₂)₂, —OOC(CH₃)C═CH₂, —OCH₂—CH(O)CH₂, —NH—CO—N—CO—(CH₂)₅, —NH—COO—CH₁₃, —NH—COO—CH₂—CH₃, —NH—(CH₂)₃Si(OR)₃, —Sₓ—(CH₂)₃Si(OR)₃, —SH, —NR′R″R″′ wherein
R′=alkyl, aryl;
R″=H, alkyl, aryl;
R″′=H, alkyl, aryl, benzyl, C₂H₄NR″″R″″′ with R″″=H, alkyl and
R″″′=H, alkyl
g) Organosilanes of the type (R″)ₓ(RO)_{y}Si(CH₂)m-R′
   R″ =alkyl

$$\begin{matrix}x + y = 2 = cycloalkyl x = 1.2 \\ y = 1.2 \\ m = 0.1 to 20\end{matrix}$$

R′=methyl-, aryl (for example, —C₆H₅, substituted phenyl residues), C₄F₉, OCF₂—CHF—CF₃, —C₆F₁₃, —O—CF₂—CHF₂, —NH₂, —N₃, —SCN, —CH═CH₂, —NH—CH₂—CH₂—NH₂, —N—(CH₂—CH₂—NH₂) —OOC(CH₃)C═CH₂, —OCH₂—CH(O)CH₂, —NH—CO—N—CO—(CH₂)₅, —NH—COO—CH₃, —NH—COO—CH₂—CH₃, —NH—(CH₂)₃Si(OR)₃, —Sₓ—(CH₂)₃Si(OR)₃, —SH, —NR′R″R″′ wherein
R′=alkyl, aryl;
R″=H, alkyl, aryl;
R″′=H, alkyl, aryl, benzyl, C₂H₄NR″″R″″ with R″″=H, alkyl and
R″″′H, alkyl
h) Halogen organosilanes of the type X₃Si(CH₂)m-R′

$$\begin{matrix}X = C l , Br \\ m = 0.1 - 20\end{matrix}$$

R′=methyl-, aryl (for example, —C₆H₅, substituted phenyl residues), C₄F₉, OCF₂—CHF—CF₃, —C₆F₁₃, —O—CF₂—CHF₂, —NH₂, —N₃, —SCN, —CH═CH₂, —NH—CH₂-CH₂—NH₂, —N—(CH₂—CH₂—NH₂) —OOC(CH₃)C═CH₂, —OCH₂—CH(O)CH₂, —NH—CO—N—CO—(CH₂)₅, —NH—COO—CH₃, —NH—COO—CH₂—CH₃, —NH—(CH₂)₃Si(OR)₃, —Sₓ—(CH₂)₃Si(OR)₃, —SH
i) Halogen organosilanes of the type (R)X2Si(CH2)m-R′

$$X = C l , Br$$

R=alkyl, such as methyl, ethyl, propyl

$$m = 0.1 - 20$$

R′=methyl-, aryl (for example, —C₆H₅, substituted phenyl residues), C₄F₉, OCF₂—CHF—CF₃, —C₆F₁₃, —O—CF₂—CHF₂, —NH₂, —N₃, —SCN, —CH═CH₂, —NH—CH₂—CH₂—NH₂, —N—(CH₂—CH₂—NH₂) —OOC(CH₃)C=CH₂, —OCH₂—CH(O)CH₂, —NH—CO—N—CO—(CH₂)₅, —NH—COO—CH₃, —NH—COO—CH₂—CH₃, —NH—(CH₂)₃Si(OR)₃, —Sₓ—(CH₂)₃Si(OR)₃, —SH
j) Halogen organosilanes of the type (R)2XSi(CH2)m-R′

$$X = C l , Br$$

R=alkyl

$$m = 0.1 - 20$$

R′=methyl-, aryl (for example, —C₆H₅, substituted phenyl residues), C₄F₉, OCF₂—CHF—CF₃, —C₆F₁₃, —O—CF₂—CHF₂, —NH₂, —N₃, —SCN, —CH═CH₂, —NH—CH₂—CH₂—NH₂, —N—(CH₂—CH₂—NH₂) —OOC(CH₃)C=CH₂, —OCH₂—CH(O)CH₂, —NH—CO—N—CO—(CH₂)₅, —NH—COO—CH₃, —NH—COO—CH₂—CH₃, —NH—(CH₂)₃Si(OR)₃, —Sₓ—(CH₂)₃Si(OR)₃, —SH

Preferably, as surface modifying agent, the following silanes are employed, either individually or in a mixture: dimethyldichlorosilane, octyltrimethoxysilane, oxtyltriethoxysilane, hexamethyldisilazane, 3 methacryloxypropyltrimethoxysilane, 3 methacryloxypropyltriethoxysilane, hexadecyltrimethoxysilane, hexadecyltriethoxysilane, dimethylpolysiloxane, glycidyloxypropyltrimethoxysilane, glycidyloxypropyltriethoxysilane, nanofluorohexyltrimethoxysilane, tridecafluorooctyltrimethoxysilane, tridecafluorooctyltriethoxysilane, aminopropyltriethoxysilane. Especially preferably, octyltrimethoxysilane and octyltriethoxysilane can be employed.

Through surface modification of the pyrogenically produced MgO, hydrophobic MgO is also produced. The pyrogenically produced MgO may be used in its hydrophilic and hydrophobic forms. The use of the hydrophilic MgO does not require any further treatment by any hydrophobic reagents, such as silanes, after their synthesis by a pyrogenic process. However, further treatment with a hydrophobic reagent, such as silanes, after their synthesis by a pyrogenic process the MgO particles can become hydrophobic. Both the hydrophilic and the hydrophobic forms of the fumed, nanostructured MgO may be used effectively as coatings using the process of the present invention via dry mixing with the substrate active cathode material. The fumed, nanostructured and surface modified MgO is preferred because it shows more homogeneous coverage of the substrate active cathode material.

The MgO particles produced via the pyrogenic process usually have a purity of at least 96% by weight, preferably at least 98% by weight, more preferably at least 99% by weight. The magnesium oxide used in the inventive process preferably contains the elements Cd, Ce, Fe, Na, Nb, P in proportions of<10 ppm and the elements Ba, Bi, Cr, K, Mn, Sb in proportions of<5 ppm, where the sum of the proportions of all of these elements is<100 ppm. The proportion of carbon in hydrophilic, non surface-modified metal oxides is preferably less than 0.2% by weight, more preferably 0.005%-0.2% by weight, even more preferably 0.01%-0.1% by weight, based on the mass of the metal oxide powder.

### Active Cathode Material

The term “transition metal” in the context of the present invention comprises the following elements: Ti, V, Cr, Mn, Fe, Co, Ni, Cu, Zn, Nb, Mo, Ru, Rh, Pd, Ag, Cd, Ta, W, Re, Os, Ir, Pt, Au. Preferably, the transition metal is chosen from the group consisting of nickel, manganese, cobalt, and a mixture thereof.

The mixed lithium transition metal oxide used with preference in the process according to the invention is selected from the group consisting of lithium-cobalt oxides, lithium-manganese oxides, lithium-nickel-cobalt oxides, lithium-nickel-manganese-cobalt oxides, lithium-nickel-cobalt-aluminium oxides, lithium-nickel-manganese oxides, and a mixture thereof.

The mixed lithium transition metal oxide preferably has a general formula LiMO₂, wherein M is at least one transition metal selected from nickel, cobalt, manganese; more preferably M=Co or NiₓMn_{y}Co_{z}, wherein 0.3≤x≤0.9, 0≤y≤0.45, 0≤z≤0.4; most preferably M is NiₓMn_{y}Co_{z}, wherein 0.3≤x≤0.9, 0≤y≤0.45, 0≤z≤0.4.

The mixed lithium transition metal oxide of the general formula LiMO₂ can be further doped with at least one other metal oxide, particularly with aluminium oxide and/or magnesium oxide.

The coated mixed lithium transition metal oxide preferably has a numerical mean particle diameter of 2-20 μm. A numerical mean particle diameter can be determined according to ISO 13320:2009 by laser diffraction particle size analysis.

The proportion of the magnesium oxide in the coated mixed lithium transition metal oxide is preferably 0.05%-5% by weight, more preferably 0.1%-2% by weight, based on the total weight of the coated mixed lithium transition metal oxide. If the proportion of the magnesium oxide is less than 0.05% by weight, no beneficial effect of the coating can usually be observed yet. In the case of more than 5% by weight thereof, no beneficial effect of the additional quantity of the magnesium coating of more than 5% by weight is usually observed.

The coated mixed lithium transition metal oxide preferably has a coating layer thickness of 10-200 nm, as determined by TEM analysis.

The present invention further provides a coated mixed lithium transition metal oxide obtainable by the process according to the invention. The invention further provides a coated mixed lithium transition metal oxide containing a pyrogenically produced, nanostructured and surface modified magnesium oxide coating on the surface of the mixed lithium transition metal oxide.

The further preferred features of the coated mixed lithium transition metal oxide, of the pyrogenically produced, nanostructured and surface modified magnesium oxide described above in the preferred embodiments of the process according to the present invention are also the preferred features of the coated mixed lithium transition metal oxide, the pyrogenically produced, nanostructured and surface modified magnesium oxide, in respect to the coated mixed lithium transition metal oxide according to the present invention, independent on whether it is produced by the inventive process or not.

The invention further provides an active positive electrode material for a lithium-ion battery comprising the coated mixed lithium transition metal oxide according to the invention or the coated mixed lithium transition metal oxide obtainable by the process according to the invention.

The positive electrode, cathode, of the lithium-ion battery usually includes a current collector and an active cathode material layer formed over or on the current collector. The current collector may be an aluminium foil, copper foil, a nickel foil, a stainless-steel foil, a titanium foil, a polymer substrate coated with a conductive metal, or a combination thereof.

The active positive electrode materials which are coated with the pyrogenically produced, nanostructured, and preferably surface modified MgO may include any suitable materials capable of reversible intercalating/deintercalating lithium ions. Such materials are well known in the art. Such active cathode material may include, for example, transition metal oxides, such as mixed oxides comprising Ni, Co, Mn, V or other transition metals and optionally lithium. Especially preferred are the mixed lithium transition metal oxides comprising nickel, manganese and cobalt (NMC).

The invention also provides a lithium-ion battery comprising the coated mixed lithium transition metal oxide or the coated mixed lithium transition metal oxide obtainable by the process according to the invention.

The lithium-ion battery of the invention, apart from the cathode, may also comprise an anode, optionally a separator and an electrolyte comprising a lithium salt or a lithium compound.

The anode of the lithium-ion battery may comprise any suitable material, commonly used in the secondary lithium-ion batteries, capable of reversible intercalating/deintercalating lithium ions. Typical examples thereof are carbonaceous materials including crystalline carbon such as natural or artificial graphite in the form of plate-like, flake, spherical or fibrous type graphite; amorphous carbon, such as soft carbon, hard carbon, mesophase pitch carbide, fired coke and the like, or mixtures thereof. In addition, lithium metal or conversion materials (e.g., Si or Sn), silicon oxide, and mixtures or composites of silicon, silicon oxide and carbon can be used as anode active materials.

The electrolyte of the lithium-ion battery can be in the liquid, gel or solid form. The liquid electrolyte of the lithium-ion battery may comprise any suitable organic solvent commonly used in the lithium-ion batteries, such as anhydrous ethylene carbonate (EC), dimethyl carbonate (DMC), propylene carbonate, methylethyl carbonate, diethyl carbonate, gamma butyrolactone, dimethoxyethane, fluoroethylene carbonate, vinylethylene carbonate, and a mixture thereof

The gel electrolytes include gelled polymers. Any suitable gelled polymers may be used.

The solid electrolyte of the lithium-ion battery may comprise oxides, e.g., lithium metal oxides, sulfides, phosphates, or solid polymers.

The electrolyte of the lithium-ion battery can contain a lithium salt. Examples of such lithium salts include lithium hexafluorophosphate (LiPF₆), lithium bis 2-(trifluoromethylsulfonyl) imide (LiTFSI), lithium perchlorate (LiCIO₄), lithium tetrafluoroborate (LiBF₄), Li₂SiF₆, lithium triflate, LIN(SO₂CF₂CF₃)₂ and mixtures thereof.

The invention further provides use of the coated mixed lithium transition metal oxide in an active positive electrode material of a lithium-ion battery.

Even without further explanations, it is assumed that a person skilled in the art can fully use the above description. The preferred embodiments and examples are therefore to be understood only as a descriptive, by no means as a limiting in any way.

In the following, the present invention is explained in more detail using examples. Alternative embodiments of the present invention are available in an analogous manner.

### EXAMPLES

### Determination of the Physical-Chemical Characteristic Data

In the context of the present invention the following measurement methods for evaluating the characteristics for the different materials were used:

A) BET surface area:
The BET surface area is determined in accordance with DIN 9277:2014 with nitrogen.

B) Tamped density:
Determination of the tamped density in adaptation of DIN ISO 787/XI,
Fundamentals of the tamped density determination:
The tamped density (formerly the tamped volume) is equal to the quotient of the mass and the volume of a powder after tamping in the tamping volumeter under predetermined conditions. In accordance with DIN ISO 787/XI, the tamped density is given in g/cm³. Because of the very low tamped density of the oxides, however, the value is given in g/L by us. Furthermore, the drying and sieving as well as the repetition of the tamping operation is dispensed with.

Apparatus for tamped density determination:
Tamping volumeter
Volumetric cylinder
Laboratory scale (Reading to 0.01 g)

Carrying out the tamped density determination:
200±10 mL of oxide is filled into the volumetric cylinder of the tamping volumeter in such a way that no pores remain, and the surface is level. The mass of the filled sample is determined precisely to 0.01 g. The volumetric cylinder with the sample is placed in the volumetric cylinder holder of the tamping volumeter and tamped 1250 times. The volume of the tamped oxide is read off 1 time exactly.
   Evaluation of the tamped density determination

$$Tamped density ( \frac{g}{L} ) = \frac{g weighed quantity}{mL volume read off} \times 1000$$

C) pH value:
The pH value is determined in 4% aqueous dispersion for hydrophobic oxides in Water:methanol (1:1).
Reagents for the pH value determination:
Distilled or completely deionized water, pH>5.5
Methanol, p.a.
Buffer solutions pH 7.00 pH 4.66
Apparatus for pH value determination:
Laboratory scale, (Reading to 0.1 g)
Glass beaker, 250 mL
Magnetic stirrer
Magnetic rod, length 4 cm
Combined pH electrodes
pH measuring apparatus
Dispensers, 100 ml

Working procedure for the determination of the pH value:
The determination is conducted in adaptation of DIN/ISO 787/IX:
Calibration: Prior to the pH value determination, the measuring apparatus is calibrated with the buffer solutions. If several measurements are carried out in succession, a single calibration suffices.
4 g of hydrophilic oxide is stirred into a paste in a 250 ml glass beaker with 96 g (96 mL) of water by use of a dispenser and stirred for five minutes with a magnetic stirrer while the pH electrode is immersed (rpm approx. 1000 min⁻¹).

4 g of hydrophobic oxide is stirred into a paste in a 250 mL glass beaker with 48 g (61 mL) of methanol and the suspension is diluted with 48 g (48 mL) of water and stirred for five minutes with a magnetic stirrer while the pH electrode is immersed (rpm approx. 1000 min⁻¹). After the stirrer has been switched off, the pH is read off after a standing time of one minute. The result is given to within one decimal place.

D) Drying loss

In contrast to the weighed quantity of 10 g mentioned in DIN ISO 787 II, a weighed quantity of 1 g is used for the drying loss determination.
The cover is put in place prior to cooling. A second drying is not conducted.
Approximately 1 g of the sample is weighed precisely to 0.1 mg into a weighing dish with a ground cover that has been dried at 105° C., the formation of dust being avoided, and dried for two hours in the drying cabinet at 105° C. After cooling in a desiccator with its cover still on, the sample is reweighed under blue gel.

$$\% Drying loss at 105 ° C . = \frac{g weight loss}{g weighed quantity} \times 100$$

The result is given to within one decimal place.

E) Loss on ignition
Apparatus for the determination of the loss on ignition:
Porcelain crucible with crucible cover
Muffle furnace
Analysis scale (Reading to 0.1 mg)
Desiccator
Carrying out the Loss on Ignition:

In departure from DIN 55 921, 0.3-1 g of the undried substance is weighed to precisely 0.1 mg into a porcelain crucible with a crucible cover, which have been heated red hot beforehand, and heated red hot for 2 hours at 1000° C. in a muffle furnace. The formation of dust is to be carefully avoided. It has proven advantageous to place the weighed samples into the muffle furnace while the latter are still cold. Slow heating of the furnace prevents the creation of stronger air turbulence in the porcelain crucible. After 1000° C. has been reached, red-hot heating is continued for a further 2 hours. Subsequently, a crucible cover is put in place and the weight loss of the crucible is determined in a desiccator over blue gel.

Evaluation of the determination of the loss on ignition

Because the loss on ignition is determined relative to the sample dried for 2 h at 105° C., the following calculation formula results:

$$\% Loss of ignition = \frac{m 0 * \frac{100 - T V}{100} - {m}_{1}}{m 0 * \frac{100 - T V}{100}} * 100$$

m0 =weighed quantity (g)
TV =drying loss (%)
m1=weight of the sample after being heated red hot(g)
The result is given to within one decimal place.

F) Carbon content

The carbon content is determined by elemental analysis using a LECO C744 instrument. The measurement principle is based on oxidizing the carbon in the sample to CO₂, which is then quantified by infrared detectors.

G) SEM Measurements

The energy dispersive X-ray spectroscopy (EDX) was conducted with a SEM. For the EDX mapping a representative area of the sample was used at a magnification of 1000×, the image width was 2048×1536 pixel (120 μm×90,1 μm) resulting in a pixel resolution of 0.059 μm. The mapping was recorded with an acceleration voltage of 20 kV. Subsequent to the measurement the elements present in the sample were determined using the sum-spectrum of the mapping. The threshold for image analysis was adjusted according to the semi-quantitative mass %-values of the respective element.

### Preparation of Magnesium Oxide:

### Example 1: Preparation of the Pyrogenically Prepared Magnesium Oxide

1,89 Kilogram of an aqueous solution containing 1000 g of Mg (CH₃COO)₂*4H₂O was prepared. An aerosol of 2.5 kg/h of this dispersion and 15 Nm³/h of air was formed via a two-component nozzle and sprayed into a tubular reaction with a burning flame. The burning gases of the flame consisted of 8 Nm³/h of hydrogen and 30 Nm³/h of air. Additionally, 25 Nm³/h of secondary air was used. After the reactor the reaction gases were cooled down and filtered.

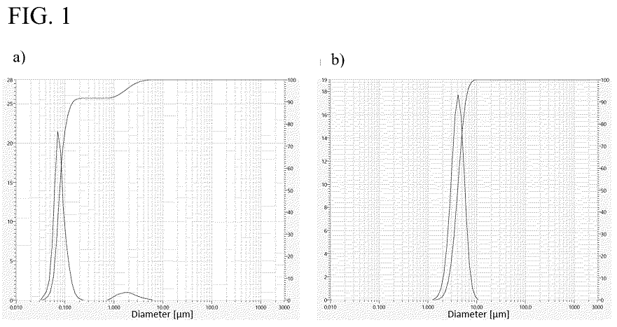

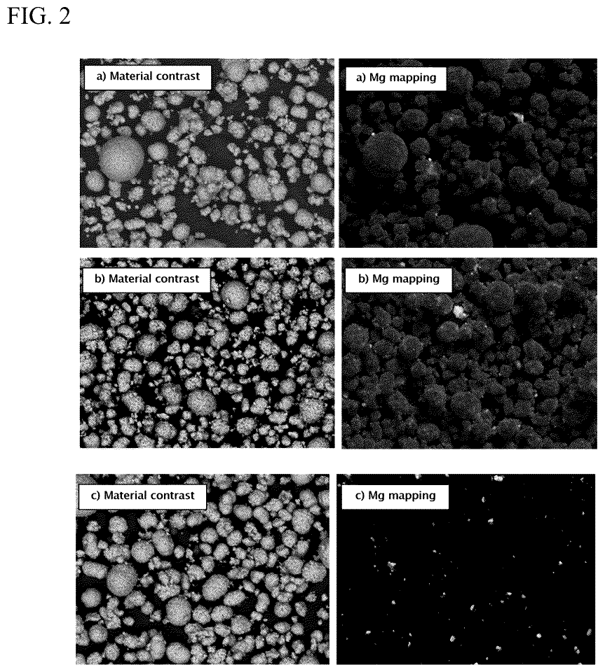

The particle properties are shown in Table 1, the TEM image of the particles is shown in FIG. 1 and the XRD analysis (FIG. 2) showed, that the major phase of the product was cubic magnesium oxide.

The high surface area, pyrogenically prepared hydrophilic magnesium oxide that forms has the physical-chemical characteristic data shown in Table I.

### Example 2: Preparation of Surface-Modified Magnesium Oxide

300 g of pyrogenically prepared magnesium oxide (example 1) are placed in a mixer and sprayed with 72 g octyltrimethoxysilane. After the spraying of the silane on the powder is finished, mixing is continued for additional 5 min. Then tempering of the wetted powder is carried out for 3 h at 130° C. in an oven. The surface modified magnesium oxide that forms has the physical-chemical characteristic data shown in Table I.

The hydrophilic and surface modified magnesium oxides have the physical-chemical characteristic data shown in Table 1.

TABLE 1
Properties

| Properties | Example 1 | Example 2 |
|---|---|---|
| BET [m²/g] | 240 | 225 |
| Tamped Density [g/L] | 56 | 78 |
| pH value | 10.5 | 10.2 |
| Drying loss [%] | 0.5 | 0.6 |
| Loss on ignition [%] | 12.2 | 17.6 |
| Carbon content [%] | 0.0 | 9.7 |

### Starting Materials

### Dry Coating Additives:

The materials described above in examples 1 and 2 were used, i.e., the fumed magnesium oxide of Example 1 with a BET surface area of 250 m²/g and the fumed hydrophobic magnesium oxide of Example 2 with a BET surface area of 230 m²/g, Evonik Operations GmbH. The fumed hydrophobic magnesium oxide of Example 2 was made hydrophobic by subjecting it to hydrophobization treatment following the pyrogenic formation process as described above. Non-fumed magnesium oxide with BET surface area of 65 m²/g, purchased from Sigma-Aldrich, Germany was also used as a comparative example. The non-fumed magnesium oxide is not nanostructured, it is a milled material with isolated, non-aggregated particles.

Cathode active material: Commercial mixed lithium nickel manganese cobalt oxide powder NMC 7 1.5 1.5 powder (type PLB-H7) with a BET surface area of 0.5 m²/g, a medium particle diameter d₅₀=10.6±2 μm (determined by static laser scattering method) supplied by Linyi Gelon LIB Co.

### Example 3

The NMC-powder (PLB-H7) in an amount of 217,8 g was mixed with 2,2 g (1.0 wt. %) of the fumed, nanostructured MgO of Example 1 powder in a high intensity laboratory mixer (Somakon mixer MP-GL with a 0.5 L mixing unit) at first for 1 min at 100 rpm (specific electrical power: 800 W/kg NMC). For homogenization of the two powders, the speed was increased step by step from the 1 min at 100 rpm to another 1 min at 200 rpm, and then another 1 min at 500 rpm. After homogenization, the mixing speed was further increased to 2000 rpm (specific electrical power: 800 W/kg NMC, tip-speed of the mixing tool in the mixing unit: 10 m/s) and the mixing was continued for 5 min to achieve the dry coating of the NMC particles with the MgO. The coated NMC particles showed a MgO-coating layer thickness of 10-200 nm, as determined by TEM analysis.

Example 4

The procedure of Example 1 was repeated exactly with the only difference, that the surface modified MgO of Example 2 was used instead of the MgO of Example 1. The coated NMC particles showed a MgO-coating layer thickness of 10-200 nm, as determined by TEM analysis.

### Comparative Example 5

The procedure of Example 1 was repeated exactly with the only difference, that the non-fumed magnesium oxide with BET surface area of 65 m₂/g, purchased from Sigma-Aldrich powder was used instead of the fumed MgO of Example 1.

Homogenously coated cathode active material particles are achieved when using fumed magnesium oxide as coating additive with a coating layer thickness of 20-200 nm on top of the cathode active material particles.

The particle size distribution for the hydrophilic magnesium oxides was measured to visualize the dispersibility behaviour during applying shear forces to the magnesia agglomerates.

FIG. 1(a) shows the particle size distribution of the fumed MgO of Example 1 and FIG. 1(b) shows the particle size distribution of the non-fumed magnesium oxide used in Example 5, analysed by a laser diffraction particle size analyser. The x axis in FIG. 1 shows the diameter of the particles, the left y axis shows volume in % (“q %”), and the right y axis shows cumulative volume in (“Q %”).

The samples were dispersed in distilled water and treated for 15 minutes in an external ultrasonic bath (160W). For the MgO of Example 1, an almost mono-modally and very narrow particle size distribution was detected with small aggregate sizes of D10=58 nm, D50=78 nm, D90 =147 nm. In the case of the non-fumed magnesium oxide, a slightly broader particle size distribution was detected with much larger agglomerate sizes of D10=2680 nm, D50=4080 nm, D90 =5950 nm, clearly revealing the presence of non-dispersed particles.

### Analysis of MgO Coated Mixed Lithium Transition Metal Oxides by SEM-EDX

FIGS. 2a, 2b, and 2c show the SEM-EDX (scanning electron microscope with energy dispersive X-ray) mapping of the different magnesia coating additives on the NMC cathode active material PLB-H7 (a: fumed hydrophobic MgO of Example 2, b: fumed MgO Example 1, c: non-fumed magnesium oxide). The mappings of NMC coated by fumed magnesia (a) and (b) show a fully and homogeneous coverage of MgO around all cathode particles. No or only very few larger magnesium oxide agglomerates were detected, showing that the dispersion of nanostructured fumed magnesia was successful. Additionally, almost no unattached MgO particles next to the cathode particles were found, indicating the strong interaction of the high surface area fumed magnesium oxide particles with the cathode active material particle surface and therefore an excellent adhesion between coating layer and substrate.

In contrast, by using coarser magnesia particles (non-fumed magnesium oxide) as coating for cathode materials (c), almost no coating layer on the surface of the cathode active material particles can be found. Instead, larger, non-dispersed and therefore unattached MgO particles are located next to the cathode particles, indicating the very poor dispersibility behaviour of the non-fumed magnesium oxide during the dry coating process, finally leading to the presence of non-coated cathode active material particles.

Hence, NMC mixed oxide dry coated with fumed MgO, shows a full and homogeneous coverage of all NMC particles with MgO. No larger MgO agglomerates were detected, showing a good dispersibility of nanostructured fumed MgO. Additionally, no free unattached MgO-particles next to the NMC particles were found, indicating the strong adhesion between coating and the substrate (NMC). In contrast, FIG. 2(c) shows that for the non-fumed MgO only the fine particles of “nano MgO” are attached to the surface of the NMC particles. The larger MgO-particles are non-dispersed and are therefore unattached, located next to the NMC particles. As a result, the NMC particles are not fully covered by magnesium oxide.

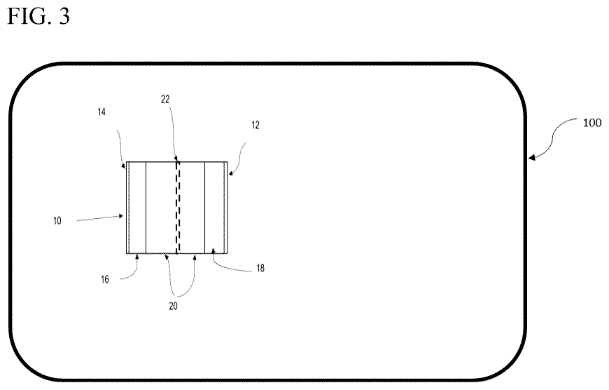

FIG. 3 shows a lithium-ion battery generally designated with numeral 10 inside an apparatus 100 powered by the lithium-ion battery 10 according to an embodiment of the present invention. The apparatus may be any electronic device such as, for example, a mobile phone, an electronic watch, a key fab, a laptop computer, a desktop computer, a computer pad and the like. The apparatus may also be an electrical apparatus such as a power tool, a vacuum cleaner, an electrical lawn mower, an electrical appliance, and the like. The lithium-ion battery 10 may be packaged in modules, each module having a plurality of lithium batteries 10, and used to power electric vehicles or hybrid vehicles. The lithium-ion battery 10 comprises negative and positive current collectors 14, and 12, a cathode 18 adjacent to the positive current collector 12, and anode 16 adjacent to the negative current collector 14, an electrolyte 20 and a separator 22 disposed between the anode 16 and cathode 18. The cathode 18 comprises a coated mixed lithium transition metal oxide as the active cathode material and is characterized in that the coated mixed lithium transition metal oxide is obtained by subjecting a mixed lithium transition metal oxide and a pyrogenically produced, nanostructured magnesium oxide to dry mixing by means of a mixing unit as described above.

Although the present invention has been described in reference to specific examples it should be understood that the invention is not limited to these examples only and many variations thereof will fall within the scope of the invention as defined by the accompanying claims.

List of Reference Numerals

| | |
|---|---|
| 10 | battery cell |
| 100 | apparatus powered by battery cell |
| 12 | positive current collector |
| 14 | negative current collector |
| 16 | anode |
| 18 | cathode |
| 20 | electrolyte |
| 22 | separator |

1. A process for producing a coated mixed lithium transition metal oxide, the process comprising;
dry mixing a mixed lithium transition metal oxide and a pyrogenically produced, nanostructured magnesium oxide (MgO) in a mixing unit under shearing conditions,
wherein the coated mixed lithium transition metal oxide is in a form of particles, and the magnesium oxide has a BET surface area according to DIN 9277:2014 of 5-300 m²/g, a mono-modally and narrow particle size distribution with a mean aggregate diameter d₅₀ of 5-150 nm, as determined by static light scattering (SLS) after 60 seconds of ultrasonic treatment at 25° C. of a mixture consisting of 5% by weight of the particles and 95% by weight of a 0.5 g/L solution of sodium pyrophosphate in water.

2. The process according to claim 1, wherein (i) the pyrogenically produced, nanostructured magnesium oxide is surface treated to become hydrophobic by reacting the hydroxyl groups of the MgO with a silane to form —O—Si—R groups prior to the dry mixing, and (ii) the mixing unit has a specific electrical power of 0.05-1.5 kW per kg of a mixed lithium transition metal oxide.

3. The process according to claim 1, wherein the mean aggregate diameter d₅₀ is 10-120 nm, as determined by SLS after 60 seconds of ultrasonic treatment at 25° C. of a mixture consisting of 5% by weight of the particles and 95% by weight of a 0.5 g/L solution of sodium pyrophosphate in water.

4. The process according to claim 1, wherein the MgO is fully and homogeneously covered substantially around all the mixed lithium transition metal oxide particles. as determined by scanning electron microscopy with energy dispersive X-ray (SEM-EDX) mapping of the coated mixed lithium transition metal oxide.

5. The process according to claim 1, wherein the specific electrical power of the mixing unit is 0.1-1000 kW, a volume of the mixing unit is 0.1 L to 2.5 m³, and a speed of a mixing tool in the mixing unit is 5-30 m/s.

6. The process according to claim 1, wherein a span (d₉₀-d₁₀)/d₅₀ of particles of the magnesium oxide is 0.4-1.2, as determined by SLS after 60 seconds of ultrasonic treatment at 25° C. of a mixture consisting of 5% by weight of the particles and 95% by weight of a 0.5 g/L solution of sodium pyrophosphate in water.

7. The process according to claim 1, wherein the mixed lithium transition metal oxide is selected from the group consisting of lithium-cobalt oxides, lithium-manganese oxides, lithium-nickel-cobalt oxides, lithium-nickel-manganese-cobalt oxides, lithium-nickel-cobalt-aluminum oxides, lithium-nickel-manganese oxides, and a mixture thereof.

8. The process according to claim 1, further comprising:
subjecting the coated mixed lithium transition metal oxide to a heat treatment following the dry mixing.

9. The process according to claim 1, wherein a proportion of the magnesium oxide in the coated mixed lithium transition metal oxide is 0.05%-5% by weight, based on a total weight of the coated mixed lithium transition metal oxide.

10. A coated mixed lithium transition metal oxide comprising:
mixed lithium transition metal oxide particles selected from the group consisting of lithium-cobalt oxides, lithium-manganese oxides, lithium-nickel-cobalt oxides, lithium-nickel-manganese-cobalt oxides, lithium-nickel-cobalt-aluminium oxides, lithium-nickel-manganese oxides, and a mixture thereof, and
a coating of a pyrogenically produced, nanostructured magnesium oxide on a surface of the mixed lithium transition metal oxide particles,
wherein the coated mixed lithium transition metal oxide is in a form of particles, and the magnesium oxide has a BET surface area. DIN 9277:2014. of 5-300 m²/g (DIN 9277:2014), a mono-modally and narrow particle size distribution with a mean aggregate diameter d₅₀ of 5-150 nm, as determined by static light scattering (SLS) after 60 seconds of ultrasonic treatment at 25° C. of a mixture consisting of 5% by weight of the particles and 95% by weight of a 0.5 g/L solution of sodium pyrophosphate in water.

11. The coated mixed lithium transition metal oxide of claim 10, wherein the MgO is fully and homogeneously covered substantially around all mixed lithium transition metal oxide particles, as determined by SEM-EDX mapping of the coated mixed lithium transition metal oxide particles.

12. A coated mixed lithium transition metal oxide obtainable by the process according to claim 1

13. An active positive electrode material for a lithium-ion battery comprising the coated mixed lithium transition metal oxide active according to claim 10.

14. A lithium-ion battery comprising the coated mixed lithium transition metal oxide according to claim 10.

15. An active positive electrode material for a lithium ion battery. the active positive electrode material comprising the coated mixed lithium transition metal oxide according to claim 10.

16. An apparatus, comprising:
the lithium-ion battery of claim 14, wherein the apparatus is an electric device or an electronic device.

17. The apparatus according to claim 16, wherein the apparatus is selected from the group consisting of a mobile phone, an electronic watch, a key fab, a laptop computer, a desktop computer, a computer pad, a power tool, a vacuum cleaner, an electric lawn mower, an electric appliance, and an electric vehicle.
